(19) United States
(12) Patent Application Publication
(10) Pub. No.: US 2013/0215109 A1
(43) Pub. Date: Aug. 22, 2013

(54) Designating Real World Locations for Virtual World Control

(71) Applicants: Silka Miesnieks, San Francisco, CA (US); John Sietsma, Melbourne (AU)

(72) Inventors: Silka Miesnieks, San Francisco, CA (US); John Sietsma, Melbourne (AU)

(21) Appl. No.: 13/774,791

(22) Filed: Feb. 22, 2013

Related U.S. Application Data
(60) Provisional application No. 61/601,781, filed on Feb. 22, 2012.

(51) Int. Cl. G06T 19/00

(52) U.S. Cl. CPC G06T 19/006
USPC 345/419

(57) ABSTRACT

A system and a method are disclosed for a user interface for an augmented reality system to provide directions and control to virtual content. The position of the system is determined and a ray is determined from the graphical information inlaid on the user interface. The intersection of the ray with a 3D model representing real world content is made. The intersection indicates a location to direct movement of virtual content.

### CROSS-REFERENCE TO RELATED APPLICATIONS

This application claims the benefit of U.S. provisional application 61/601,781, filed Feb. 22, 2012, which is hereby incorporated by reference in its entirety.

### BACKGROUND

1. Field of Art

The disclosure generally relates to the field of user interfaces, and more specifically to user interfaces for augmented reality systems on a mobile device.

2. Description of the Related Art

Typical control of virtual content includes a standard input mechanism, such as a keyboard, mouse, touch screen, or other controlling device. Physically separate inputs usually occupy substantial physical room. Meanwhile, touchscreen input typically produces an overlay occupying significant space on the screen and requires the user to obstruct the user's view of images on the screen when providing input. As such, there is a need for methods allowing the user of an augmented reality system to provide virtual character input using the position and orientation of the device to identify locations in the real world for controlling a virtual character.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG.) 1 shows a system for displaying augmented reality (AR) content which incorporates a control system according to one embodiment.

FIGS. 2A-B show an interface for a control system according to one embodiment.

FIG. 3 illustrates the components of a control system in an AR device according to one embodiment.

FIG. 4 illustrates the conceptual user control of virtual content using the user device.

FIG. 5 illustrates one embodiment of a view of the components of the system.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment includes a user interface for an augmented reality system to provide directions and control to virtual content. The position of the system is determined in a 3D model and a ray from the system to objects in the model is determined from graphical information inlaid on the user interface. The intersection of the ray with the 3D model representing real world content is made. The intersection indicates a location to direct movement of virtual content.

### Augmented Reality Occlusion

FIG. 1 shows an overview of a system for displaying augmented reality (AR) content according to one embodiment. The user uses a mobile device 102, which includes in one embodiment a camera, inertial sensors and a screen. The mobile device 102 depicts real world objects 103 which can be viewed as real world objects 103 on a live video 104 on the screen. The real world objects 103 are translated into an internal three-dimensional representation. The mobile device uses the video captured by the camera as well as inertial sensors to determine the position (“pose”) of the mobile device 102 with respect to the real world objects 103 and within the internal three-dimensional representation. Using the pose of the mobile device 102, virtual content 101 is superimposed on the real world objects 103 on the screen of the mobile device 102. In one embodiment, the pose of the mobile device 102 is calculated using the video captured by the camera as well as the inertial sensors. Using the pose of the mobile device 102, the system overlays the virtual content 101 so that the virtual content 101 appears to be fixed with respect to the real world displayed on the screen. As the mobile device 102 is moved in space relative to real world objects 103, the location of the virtual content 101 is identified and maintained relative to the real world objects 103 displayed on the screen.

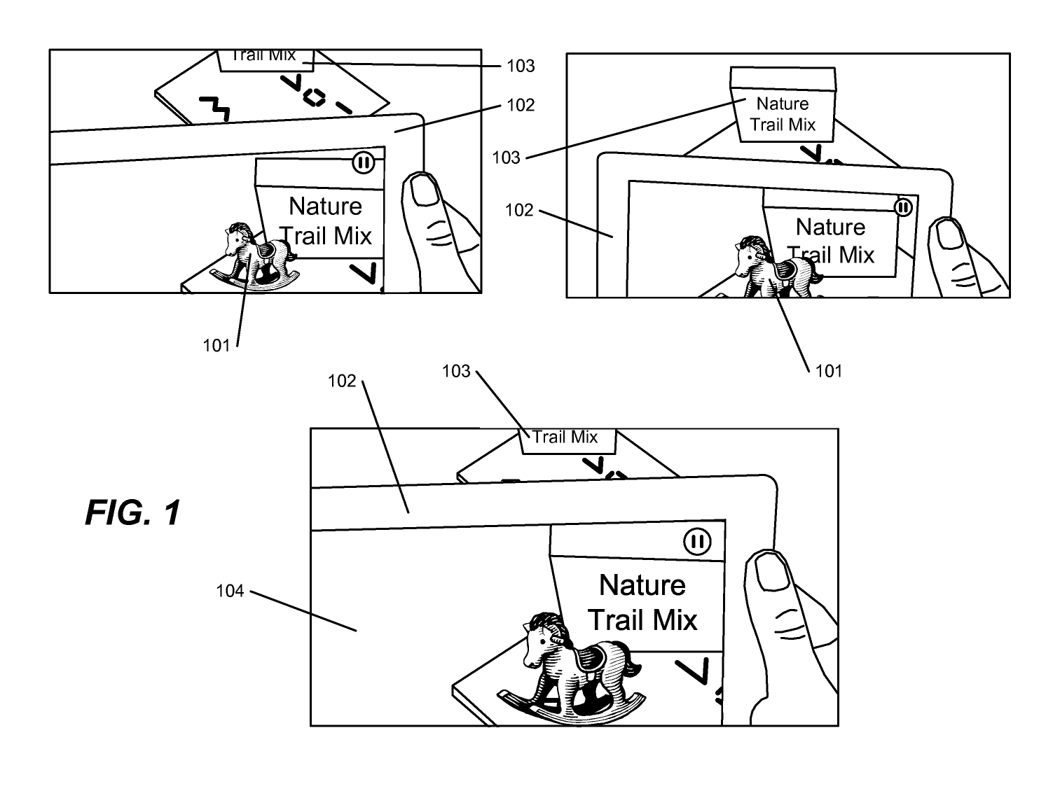

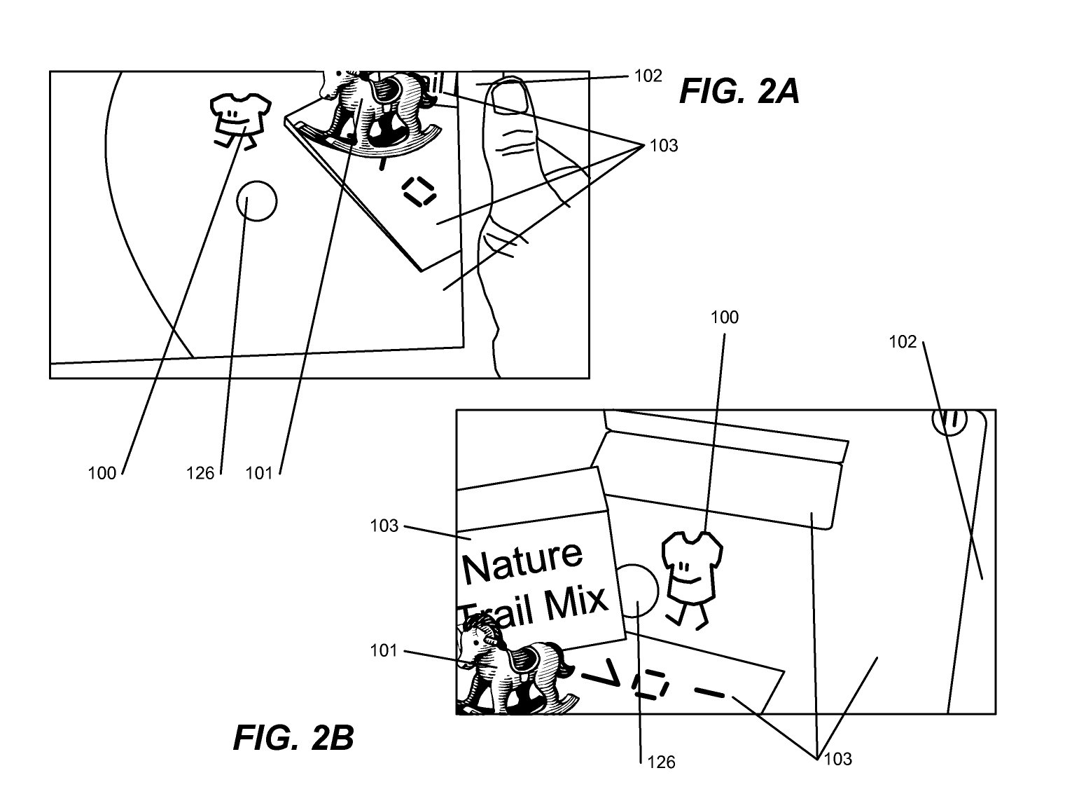

Referring to FIGS. 2A-B, an interface is provided for controlling virtual content. FIGS. 2A and 2B illustrate views of the screen for the mobile device 102. As shown, this interaction interface allows a user using a mobile device 102 to designate a real world location to direct the virtual character using target graphics 126. The virtual character 100 is part of the virtual content 101 overlaid on the video of the real world. The user designates the real world location by aligning target graphics 126 with the desired real world location seen on the interface in FIG. 2. The mobile device 102 identifies a virtual location corresponding to the real world location within the mobile device 102's model of the real world. That location is in turn used to direct the virtual character 100 displayed by the AR system to move to that location. From the user perspective shown by FIG. 2A, the virtual character 100 is directed towards the targeting graphics 126 and walks “down” accordingly. From the user perspective shown in FIG. 2B, the virtual character is directed towards the “left.” As shown on FIG. 2B, the target graphic 126 may be placed behind a real-life object 103, indicating the virtual character 100 will move behind the real-life object 103. The target graphic 126 is placed in front or behind the real-life object based on whether the user directed the target graphic 126 to the object from a position in front or behind the real-life object 103.

### Augmented Reality System Components

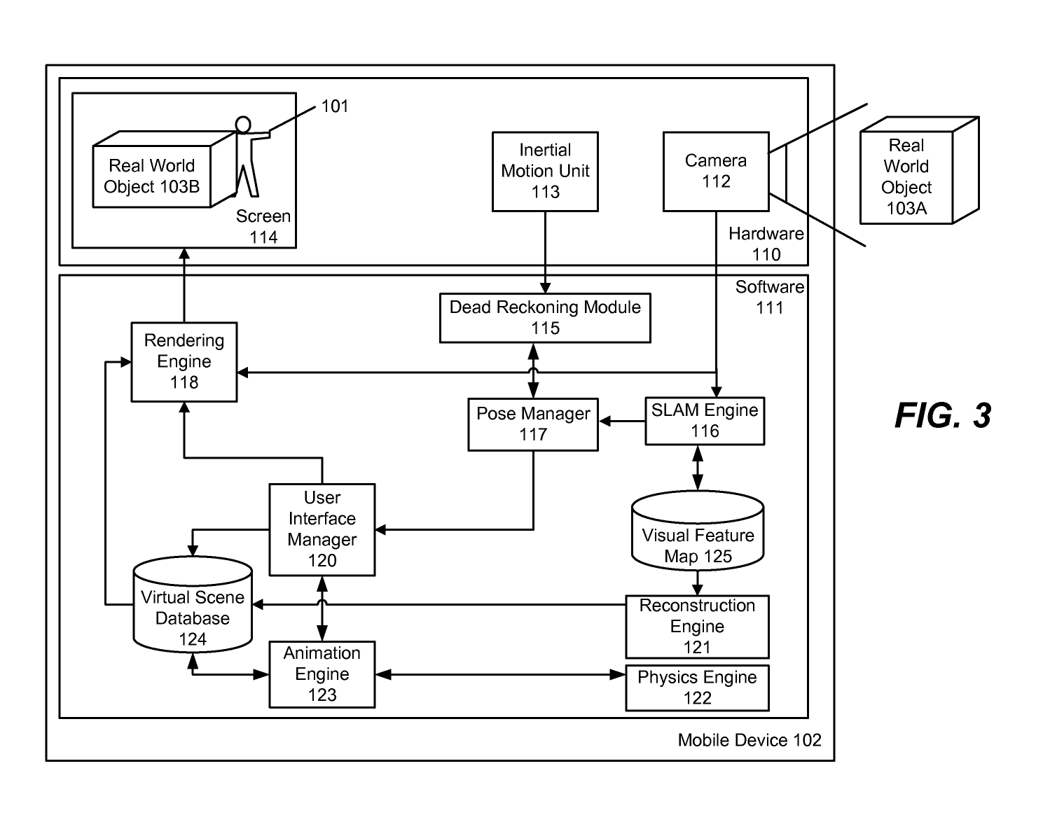

Referring now to FIG. 3, the components of an AR system are shown according to one embodiment. As shown in this embodiment, the mobile device includes several hardware components 110 and software components 111. In varying embodiments, the software components 111 may be implemented in specialized hardware rather than implemented in general software or on one or more processors.

The hardware components 110 in one embodiment include a camera 112, an inertial motion unit 113, and a screen 114. The camera 112 captures a video feed of real objects 103. The video feed is provided to other components of the system to enable the system to determine the pose of the system relative to real objects 103, construct a three-dimensional representation of the real objects 103, and provide the augmented reality view to the user.

The inertial motion unit (IMU) 113 is a sensing system composed of several inertial sensors which includes an accelerometer, gyroscope, and magnetometers. In other embodiments, additional sensing systems are used which also provide information about movement of the mobile device 102 in space. The IMU provides inertial motion parameters to the software 111. The IMU is rigidly attached to the mobile device 102 and thereby provides a reliable indication of the movement of the entire system and can be used to determine the pose of the system relative to the real world objects 103A viewed by the camera 112. The inertial parameters provided by the IMU include linear acceleration, angular velocity and gyroscopic orientation with respect to the ground.

The screen 114 displays a live video feed 104 to the user and can also provide an interface for the user to interact with the mobile device 102. The screen 114 displays the real world object 103B and rendered virtual content 101. As shown here, the rendered virtual content 101 may be at least partially occluded by the real world object 103B on the screen 114.

The software components 111 provide various modules and functionalities for enabling the system to place virtual content with real content on the screen 114. The general functions provided by the software components 111 in this embodiment are to identify a three-dimensional representation of the real world objects 103A, to determine the pose of the mobile device 102 relative to the real world objects 103A, to render the virtual content using the pose of the mobile device with respect to the real world objects, and to enable user interaction with the virtual content and other system features. The components used in one embodiment to provide this functionality are further described below.

The software 111 includes a dead reckoning module (DRM) 115 to compute the pose of the mobile device 102 using inertial data. That is, the DRM 115 uses the data from the IMU 113 to compute the inertial pose, which is the position and orientation of the mobile device 102 with respect to the real world objects 103. DRM 115 uses dead-reckoning algorithms to iteratively compute the pose relative to the last computed pose using the measurements from the IMU 113. In one embodiment, the DRM calculates the relative change in pose of the mobile device 102 and further provides a scale for the change in pose, such as inches or millimeters.

A Simultaneous Localization and Mapping (SLAM) engine receives the video feed from the camera 112 and creates a three-dimensional (3D) spatial model of visual features in the video frames. Visual features are generally specific locations of the scene that can be easily recognized from the rest of the scene and followed in subsequent video frames. For example, the SLAM engine 116 can identify edges, flat surfaces, corners, and other features of real objects. The actual features used can change according to the implementation, and may vary for each scene depending on which type of feature provides the best object recognition. The features chosen can also be determined by the ability of the system to follow the particular feature frame-by-frame. By following those features in several video frames and thereby observing those features from several perspectives, the SLAM engine 116 determines the 3D location of each feature through stereoscopy and creates a visual feature map 125.

In addition, the SLAM engine 116 further correlates the view of the real world captured by the camera 112 with the visual feature map 125 to determine the pose of the camera 112 with respect to the scene 103. This pose is also the pose of the hardware assembly 110 or the device 102 since the camera is rigidly attached and part of those integrated components.

The pose manager 117 manages the internal representation of the pose of the mobile device 102 relative to the real world. The pose manager 117 obtains the pose information provided by the dead reckoning module 115 and the SLAM engine 116 and fuses the information into a single pose. Generally, the pose provided by the IMU is most reliable when the mobile device 102 is in motion, while the pose provided by the SLAM engine 116 (which was captured by the camera 112) is most reliable while the mobile device 102 is stationary. By fusing the information from the both poses, the pose manager 117 generates a pose which is more robust than either alone and can reduce the statistical error associated with each.

The pose estimation function determines the pose of the hardware assembly 110 or system 102. The pose manager 117 computes this pose by fusing the inertial-based pose computed by the dead-reckoning module 115 and the vision based pose computed by the SLAM engine 116 using a fusion algorithm and makes that pose available for other software components. The fusion algorithm can be, for example, a Kalman filter. The SLAM engine 116 produces the vision-based pose using a SLAM algorithm, using camera video frames from different perspectives of the scene 103 to create a visual map 125. It then correlates the live video from the camera 112 with this visual feature map 125 to determine the pose of the camera with respect to the scene 103. The DRM 115 produces the inertial-based pose using the raw inertial data coming from the IMU 113.

The visual feature map 125 is a data structure which encodes the 3D location and other parameters describing the visual features generated by the SLAM engine 116 as the scene 103A is observed. For example, the visual feature map 125 may store points, lines, curves, and other features identified by the SLAM engine from the real world objects 103A.

The reconstruction engine 121 uses the visual feature map 125 generated by the SLAM engine 116 to create a surfaced model of the scene 103 by interpolating surfaces from the said visual features. That is, the reconstruction engine 121 accesses the raw feature data from the visual feature map 125 (e.g., a set of lines and points from a plurality of frames) and constructs a three-dimensional representation to create surfaces from the visual features (e.g., planes).

The scene modeling function performed by the reconstruction engine 121 creates a 3D geometric model of the scene. It takes as input the feature map 125 generated by the SLAM engine 116 and creates a geometric surface model of the scene to generate a surface from points that are determined to be part of this surface. For example in creating an implicit surface using the visual feature points as key points, or by creating a mesh out of triangles created between points that are close to each other. By controlling how many visual features are collected by the SLAM engine 116 at each frame, and in turn controlling the density of the visual map 125, the SLAM engine creates a surfaced virtual model that is close to the actual geometry of the real world being observed. The reconstruction engine 121 stores the 3D model in the virtual scene database 124.

The animation engine 123 is responsible for creating, changing, and animating virtual content. The animation engine 123 responds to animation state changes requested by the user interface manager 120 such as moving a virtual character from one point to another. The animation engine 123 in turn updates the position, orientation or geometry of the virtual content to be animated in each frame in the virtual database 124. The virtual content stored in the virtual scene database 124 is later rendered by the rendering engine 118 for presentation to the user.

The physics engine 122 interacts with the animation engine 123 to determine physics interactions of the virtual content with the three-dimensional model of the world. The physics engine 122 manages collisions between the geometry and content that it is provided with. For example, whether two geometries intersect, or whether a ray is intersecting with an object. It also provides a motion model between objects using programmable physical properties of those objects as well as gravity, so that the animation appears realistic. In particular, the physics engine 122 can provide collision and interaction information between the virtual objects from the animation engine 123 and the three-dimensional representation of the real world objects in addition to interactions between virtual content.

The virtual scene database 124 is a data structure storing both the 3D and 2D virtual content to integrate in the real world. This includes the 2D content such as text or a crosshair which is provided by the UI manager 120. It also includes 3D models in a spatial database of the real world 103A (or scene) created by the SLAM engine 116 and the reconstruction engine 121, as well as the 3D models of the virtual content to display as created by the animation engine 123. As such, the virtual scene database 124 provides the raw data to be rendered for presentation to the user's screen.

The rendering engine 118 receives the video feed from the camera 112 and adds the AR information and user interface information to the video frames for presentation to the user. The rendering engine 118's first function is to paint the video generated from the camera 112 into the screen 114. The second function is to use the pose of the device 102 (equivalent to hardware assembly 110 including the camera 112) with respect to the scene 103 and use that pose to generate the perspective view of the virtual scene database 124 from that said pose and then generate the corresponding 2D projected view 101 of this virtual content to display on the screen 114.

The rendering engine 118 renders 2D elements such as text and buttons which are fixed with respect to the screen 114 and their screen location is specified in term of screen coordinates. Those drawings are requested and controlled by the user interface manager 120 according to the state of the application. Depending on the implementation those 2D graphics are either generated every frame by application code or stored in the virtual database 124 after being created and further modified by the user interface manager 120, or a mix of both.

The rendering engine 118 “paints” the video frames captured by the camera 112 on the screen 114 so that the user is presented with a live view of the real world in front of the device, thereby creating the effect of seeing the real world through the device 102. That is, the rendering engine 118 displays the video frames captured by the camera 112 on the screen 102, which may be further modified by the rendering engine 118.

The rendering engine 118 also renders in 3D the virtual content 101 to add to the scene as seen from the viewpoint of the mobile device 102 (as determined by the pose). In this embodiment, the pose is provided by the user interface manager 120, though the pose could alternatively be provided directly by the pose manager 117. To correctly occlude rendering the virtual content 101 stored in the virtual scene database 124, the rendering engine 118 first renders from the same viewpoint the virtual model of the real scene generated by the scene modeling function. This virtual model of the real scene 103 is rendered transparently so it is invisible but the depth buffer is still being written with the depth of each pixel of this virtual model of the real world. This means when the virtual content 101 is added, it is correctly occluded depending on the relative depth at each pixel (i.e. at this specific pixel, is one model in front or behind the other) between the transparent virtual model of the scene overlaid on the real scene, and the virtual content. This produces the correct occlusion of the overlay 101 seen on the screen 114. The virtual model of the real scene 103 is rendered transparently, overlaid on the real scene 103. This means the video of the real scene 103 is clearly visible, creating the appearance of the real object 103 and the virtual content interacting.

The user interface (UI) manager 120 receives the pose of the device or hardware assembly 110 including camera 112 as reported by the pose manager 117, modifies or creates virtual content inside the virtual scene database 124, and controls the animation engine 123.

The overall application is controlled by the user interface manager 120, which stores the state of the application, and transitions to another state or produces application behaviors in response to user inputs, sensor inputs and other considerations. First the user interface manager 120 controls the rendering engine 118 depending on the state of the application. It might request 2D graphics to be displayed such as an introduction screen or some button or text to be displayed to show a high-score for example. The user manager also controls whether the rendering engine should show a 3D scene and if so uses the pose reported by the pose manager 117 and provides it as a viewpoint pose to the rendering engine 118. In addition the user manager controls the dynamic content by taking user input from buttons, finger touch events, using the pose of the device 102 itself, or using targeting graphics 126. To change the virtual content inside the database 124, the user interface manager 120 uses an animation engine 123 and sends it punctual requests of the desired end state of the virtual content, for example moving some virtual content from a real location A to a real location B. The engine 123 in turn keeps updating the virtual content every frame so that the requested end state is reached after a time specified by the user interface manager. The system 102 is further able to avoid the collision or intersection of virtual content with the real world, or more specifically the virtual model of the real world 103 created by the scene modeling process, by using a physics engine 122 which is able to determine if there is collision between two geometrical models. This allows for the animation engine 123 to control the animation at collision or to produce a motion path that prevents collision. By working with the interface manager 120, the animation engine can decide what to do with the virtual content when collision is detected, for example when the virtual content collides with the virtual model of the real scene, the animation engine 123 could switch to a new animation showing the virtual content bouncing back into the other direction.

### User Control of Virtual Content

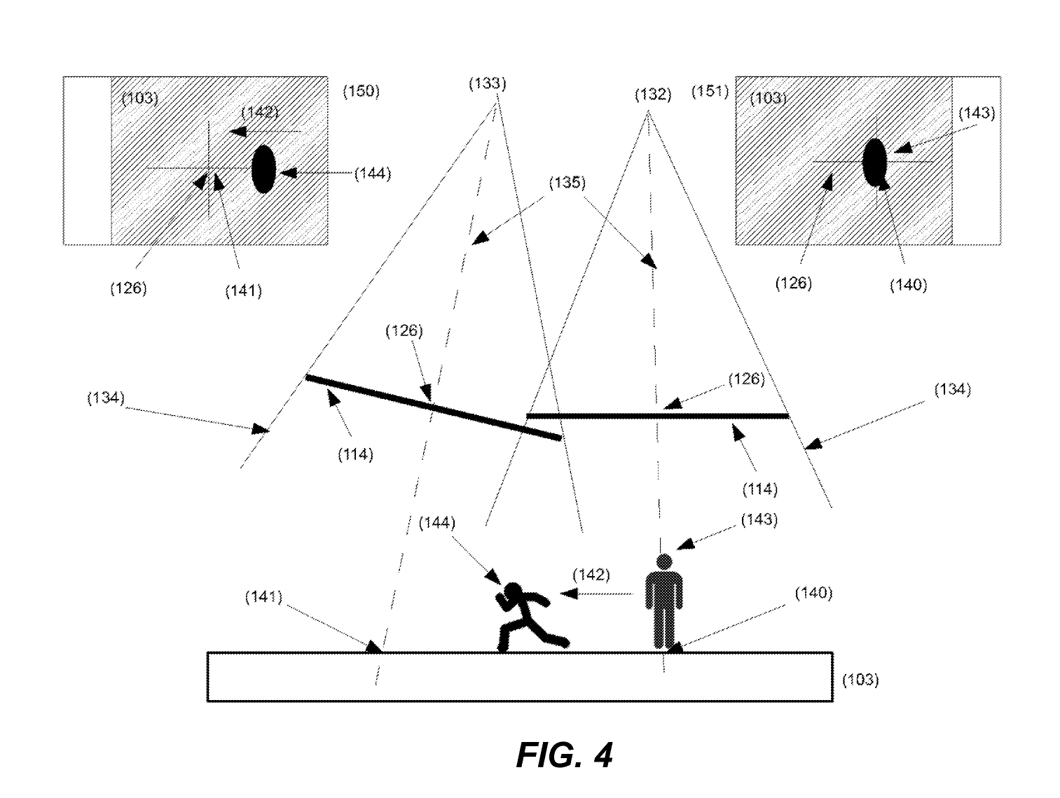

FIG. 4 illustrates the conceptual user control of virtual content using the user device 102. This figure shows a table 103 being observed through the device 102 with the field of view of the camera 134 and screen rendering 150 and 151. Pose 132 and 133 correspond to two different poses of the device looking at two different parts of the scene and 150 and 151 show the respective corresponding views shown to the user by the AR system 102. That is, screen rendering 151 corresponds to the view from pose 132 and screen rendering 150 corresponds to the view from pose 133. Illustrated in each of the screen renderings 150 and 151 are the target graphics 126 that allow the user target a position on the physical object 103 to guide the virtual content to that location. In FIG. 4 it is shown as a crosshair, but it could be any graphics that supports aiming such as the target graphics 126 shown in FIG. 2. As the user moves the device's position from 132 to 133, the system uses the target graphics 126 to identify the current location 140 and a new position 141. The virtual character 143 is set a destination at location 141, and the system determines a path 142 from the current location 140 to the target location 141. The character begins moving along the path 142 and is rendered in the user's screen in motion along the path 144. As a result, as the user moves the device 102 and the camera 112 to have the field of view 133 and to aim at the location 141, the virtual character 143 character starts to move in the path 142 of the new location being aimed at 141, and as such the character is animated as 144 to show this motion.

To perform this update, the system updates the location of the pose 132 and the location of the character relative to the target graphics 126. At each update, the user interface manager 120 request the pose of the device 102, or camera 112, or field of view 134, with respect to the scene 103. This is determined by a pose determination from the pose manager 117, which can be performed by the visual analysis using SLAM engine 116 or as an alternative or in combination with inertial sensing provided by the dead reckoning system 115. The pose is used to determine the aiming ray 135 by calculating its origin and its direction (via poses 132 or 133). The direction is specified by the focal point of the camera (132 or 133) and the target graphics 126. The aiming ray 135 is then intersected with the 3D model of the real world 103, to determine the 3D location 141 which is at the first intersection of the ray 135 with the 3D model, if that intersection exists. The location 141 computed relative to the 3D model corresponds to the same real world location by calculating the pose 133 of the device 102 and expressing the pose 133 in the same coordinate frame as is used for the 3D model. As such, the pose estimation and modeling coordinates are translated to use the same frame. Once the location 141 has been computed, the user interface manager 120 requests the animation engine 123 to move the virtual character 143 standing at location 140 to the new location being aimed at 141, thereby animating on subsequent video frame the character 144. The animation engine uses the collision engine 122 to determine if there are collisions along the path with the real world model 165 stored in the database 124 and if so determines an interaction response. The interaction response may be an alternate path around the object or a collision animation with the object. For example, the character could be directed to go from standing beside a first side of a box to stand beside the opposite side of the box. The animation engine and collision engine can provide various paths to the character, such as traveling around the box, or could animate the character interacting with the side of the box to climb it, traverse the top of the box, and climb or jump down the other side. This is possible because the 3D model maintains information about the box allowing the virtual character to interact with it. Alternatively, rather than a path or animation, the virtual content can also move instantaneously to location 141.

### Variations

In one embodiment, rather than constructing the 3D model using the reconstruction engine 121, the 3D model can be provided a priori. That is, the system may already have a 3D model of the area viewed by the user. This 3D model can be of, for example, a work station, but can also include common sights that are likely to be viewed by many users. For example, a city skyline as viewed from a popular train or bus can be provided as a 3D model and may be used rather than reconstructing the skyline for each device using the reconstruction engine 121.

Determining the intersection of the ray 135 with the 3D model (creating location 141) can be calculated using several means. For example, the ray may be input to the 3D model using the pose of the device to determine the intersection with the 3D model. In addition, the mobile device may be equipped with a range finder or a depth camera to determine the distance from the device to the surface. In this case, the depth can be used along with the pose to determine the location 141 rather than determining the intersection of the ray with the 3D model.

Using the targeting graphics 126, the mobile device 102 is able to provide control for virtual content with motion of the mobile device 102. This method doesn't rely on overlaid graphics that obscure portions of the screen or on physical buttons that may complicate control. This allows the mobile device 102 to provide control using targeting graphics in an intuitive way for the user where the user merely points the targeting graphics to the location the user desires to interact with. Though described herein as directing control of a virtual character, the targeting graphics may be used for other types of control as well. The targeting graphics 126 may be used to target objects, place virtual objects, or otherwise interact with objects in the model of the real world. For example, an interior designer may use the targeting graphics in a room to target locations to place and manipulate virtual furniture or decorations and enable easy interaction with these objects.

### Computing Machine Architecture

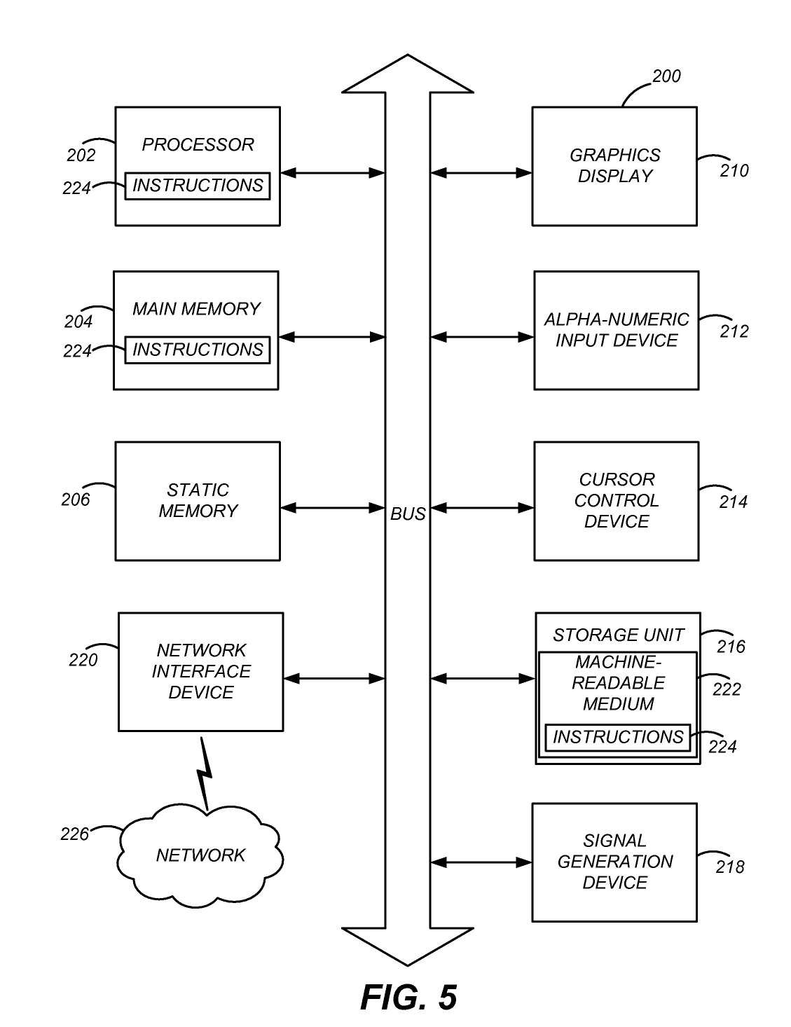

FIG. 5 is a block diagram illustrating components of an example machine able to read instructions from a machine-readable medium and execute them in a processor (or controller). Specifically, FIG. 5 shows a diagrammatic representation of a machine in the example form of a computer system 200 within which instructions 224 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment. The mobile device 102 as described earlier would have an architecture that includes aspects of the computer system 200 and its operation.

The machine may be a server computer, a client computer, a personal computer (PC), a tablet PC, a set-top box (STB), a personal digital assistant (PDA), a cellular telephone, a smartphone, a web appliance, or any machine capable of executing instructions 224 (sequential or otherwise) that specify actions to be taken by that machine. Further, while only a single machine is illustrated, the term “machine” shall also be taken to include any collection of machines that individually or jointly execute instructions 224 to perform any one or more of the methodologies discussed herein.

The example computer system 200 includes a processor 202 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 204, a static memory 206, and a camera (not shown), which are configured to communicate with each other via a bus 208. The computer system 200 may further include graphics display unit 210 (e.g., a plasma display panel (PDP), a liquid crystal display (LCD), a projector, or a cathode ray tube (CRT)). The computer system 200 may also include alphanumeric input device 212 (e.g., a keyboard), a cursor control device 214 (e.g., a mouse, a trackball, a joystick, a motion sensor, or other pointing instrument), a storage unit 216, a signal generation device 218 (e.g., a speaker), and a network interface device 220, which also are configured to communicate via the bus 208.

The storage unit 216 includes a machine-readable medium 222 on which is stored instructions 224 (e.g., software) embodying any one or more of the methodologies or functions described herein. The instructions 224 (e.g., software) may also reside, completely or at least partially, within the main memory 204 or within the processor 202 (e.g., within a processor's cache memory) during execution thereof by the computer system 200, the main memory 204 and the processor 202 also constituting machine-readable media. The instructions 224 (e.g., software) may be transmitted or received over a network 226 via the network interface device 220.

While machine-readable medium 222 is shown in an example embodiment to be a single medium, the term “machine-readable medium” should be taken to include a single medium or multiple media (e.g., a centralized or distributed database, or associated caches and servers) able to store instructions (e.g., instructions 224). The term “machine-readable medium” shall also be taken to include any medium that is capable of storing instructions (e.g., instructions 224) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIG. 3. Modules may constitute either software modules (e.g., code or instructions 224 embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor such as processor 202) that is temporarily configured by software to perform certain operations by executing instructions 124. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 202, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for capturing information about real world objects, building a three-dimensional model of the real world objects, and rendering objects capable of occlusion and collusion with the three-dimensional model for rendering on a live video through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for identifying a location in an augmented reality system comprising:
displaying a user interface to a user, the user interface including a targeting graphic and a video feed including at least one real-life object;
determining a position of a camera relative to a frame of reference for a 3D model including the at least one real-life object;
determining an orientation of the targeting graphic relative to the frame of reference;
determining an intersection point of a ray originating at the position of the camera, directed the orientation of the targeting graphic, and intersecting a real-world object in the 3D world; and
controlling a virtual object in the 3D model based on the intersection point.

2. The computer-implemented method of claim 1, wherein controlling the virtual object comprises moving the virtual object toward the intersection point.

3. The computer-implemented method of claim 2, wherein moving the virtual object comprises animating the virtual object towards the intersection point.

4. The computer-implemented method of claim 3, wherein animating the virtual object towards the intersection point includes determining a path of travel for the virtual object.

5. The computer-implemented method of claim 4, wherein the path of travel avoids collisions with a real-world object in the 3D world.

6. The computer-implemented method of claim 2, wherein moving the virtual object comprises detecting a collision of the virtual object with a real-world object in the 3D world and animating the collision of the virtual object with the real-world object.

7. A system for augmenting real-world objects with virtual content, comprising:
a processor configured to execute instructions;
a memory including instructions when executed by the processor cause the processor to:
display a user interface to a user, the user interface including a targeting graphic and a video feed including at least one real-life object;
determine a position of a camera relative to a frame of reference for a 3D model including the at least one real-life object;
determine an orientation of the targeting graphic relative to the frame of reference;
determine an intersection point of a ray originating at the position of the camera, directed the orientation of the targeting graphic, and intersecting a real-world object in the 3D world; and
control a virtual object in the 3D model based on the intersection point.

8. The system of claim 7, wherein controlling the virtual object comprises moving the virtual object toward the intersection point.

9. The system of claim 8, wherein moving the virtual object comprises animating the virtual object towards the intersection point.

10. The system of claim 9, wherein animating the virtual object towards the intersection point includes determining a path of travel for the virtual object.

11. The system of claim 10, wherein the path of travel avoids collisions with a real-world object in the 3D world.

12. The system of claim 8, wherein moving the virtual object comprises detecting a collision of the virtual object with a real-world object in the 3D world and animating the collision of the virtual object with the real-world object.

13. A computer-readable medium for augmenting real-world objects with virtual content, comprising instructions causing a processor to:
display a user interface to a user, the user interface including a targeting graphic and a video feed including at least one real-life object;
determine a position of a camera relative to a frame of reference for a 3D model including the at least one real-life object;
determine an orientation of the targeting graphic relative to the frame of reference;
determine an intersection point of a ray originating at the position of the camera, directed the orientation of the targeting graphic, and intersecting a real-world object in the 3D world; and
control a virtual object in the 3D model based on the intersection point.

14. The computer-readable medium of claim 13, wherein controlling the virtual object comprises moving the virtual object toward the intersection point.

15. The computer-readable medium of claim 14, wherein moving the virtual object comprises animating the virtual object towards the intersection point.

16. The computer-readable medium of claim 15, wherein animating the virtual object towards the intersection point includes determining a path of travel for the virtual object.

17. The computer-readable medium of claim 16, wherein the path of travel avoids collisions with a real-world object in the 3D world.

18. The computer-readable medium of claim 14, wherein moving the virtual object comprises detecting a collision of the virtual object with a real-world object in the 3D world and animating the collision of the virtual object with the real-world object.
